(19) United States
(12) Patent Application Publication
(10) Pub. No.: US 2006/0151220 A1
(43) Pub. Date: Jul. 13, 2006

(54) Apparatus capable of running using electric wheels

(75) Inventors: Makoto Taniguchi, Oobu-shi (JP); Yasuaki Yukawa, Toyoake-shi (JP); Masahiko Osada, Okazaki-shi (JP); Shin Kusase, Oobu-shi (JP); Takuzou Mukai, Handa-shi (JP)

Correspondence Address: OLIFF & BERRIDGE, PLC, P.O. BOX 19928, ALEXANDRIA, VA, 22320, US

(73) Assignee: Denso Corporation, Kariya-city (JP)

(21) Appl. No.: 11/303,945

(22) Filed: Dec. 19, 2005

(30) Foreign Application Priority Data
Dec. 20, 2004 (JP) 2004-368370

(51) Int. Cl. B60K 1/00

(52) U.S. Cl. 180/65.5; 180/65.1

(57) ABSTRACT

An apparatus having electric wheels comprises a pair of left and right wheels, rotary electric machines, i.e. motors, for individually driving these wheels, and a control unit for operating the motors. The motors each have a rotation axis offset from that of the wheel, drive the same one wheel of the pair, and are arranged at positions distanced in the radial direction of the axle by the same length, and on the same plane normal to the axial direction of the axle, being apart from each other in the circumferential direction of the axle with a predetermined angle therebetween. In a preferred mode, power is transmitted from the motors to a single wheel through a belt-type transmission mechanism incorporated in the wheel. Responsive and fine driving power control can be performed without sacrificing the cabin space, thereby providing a vehicle having excellent responsiveness, degree of freedom and reliability.

### CROSS-REFERENCE TO RELATED APPLICATION

This application is based on and claims the benefit of priority from earlier Japanese Patent Application No. 2004-368370 filed on Dec. 20, 2004, the description of which is incorporated herein by reference.

### BACKGROUND OF THE INVENTION

1. Technical Field of the Invention

The present invention relates to an apparatus capable of running using individually and electrically driven wheels, i.e., electric wheels. The present invention is applicable not only to motor vehicles, but also to other objects, such as electric wheelchairs and robots which are able to run. Also, the present invention is applicable to objects having a system in which only a pair of front wheels or a pair of rear wheels is electrically driven, as well as to objects having a system in which all of the wheels are individually and electrically driven. The electric wheels can be provided with power by any of an internal-combustion-engine-driven generator, a battery or a fuel cell.

2. Related Art

As described, for example, in Japanese Patent No. 3,333,488, electric wheel type motor vehicles have been well known, in which the wheels are individually driven by providing each of them with a rotary electric machine. The apparatus with the capability of running and having electric wheels of this type have merit in that the vehicle interiors can be made spacious since drive shafts and differential gears can be omitted.

Japanese Unexamined Patent Application Publication No. 2004-090822 suggests electric wheels in each of which the rotational axis of a wheel drive motor is offset from that of the wheel. With these types of wheels, the degree of freedom of arranging the wheel motors can be increased.

However, in the electric wheels disclosed in Japanese Unexamined Patent Application Publication No. 2004-090822, if the wheel driving power is to be increased, the radial length or the axial length of each of the rotary electric machines is also required to be increased. In practice, this has caused limitation and difficulty in mounting the rotary electric machines.

In such individually-driven-wheel type motor vehicles using the rotary electric machines, an operational failure of one of the left and right rotary electric machines for driving one of the left and right wheels can lead to unbalanced power generation between the left and right wheels, thus necessitating suppression of the power generation in the other one of the left and right wheels to match with the power generation of the wheel in failure.

### SUMMARY OF THE INVENTION

The present invention has been made in view of the disadvantages described above, for the apparatuses using rotary electric machines which are arranged with their rotational axes being offset from those of the wheels to individually drive the wheels. Thus, the object of the present invention is to provide an apparatus having the capability of running and having excellent electric wheels of reliable operation, and is capable of increasing the driving power of the wheels without increasing the radial length or the axial length of each of the rotary electric machines.

According to one aspect of the present invention, there is provided an apparatus equipped with electric wheels for movement, comprising: a single pair of right and left wheels each having a rotary shaft; a plurality of rotary electric machines driving the single pair of right and left wheels so that the wheels serve as the electric wheels, wherein the plurality of rotary electric machines each have a rotary shaft positionally shifted from the rotary shaft of each wheel and drive the same wheel of the single pair of right and left wheels; and a controller controlling operations of the rotary electric machines.

Specifically, in the present invention, all of the wheels to be electrically driven (hereinafter also referred to as “electric wheels”) are each driven by a plurality of rotary electric machines. In this manner, the power that can be supplied to the electric wheels can be increased without increasing the radial length or the axial length of each of the rotary electric machines. This may realize a vehicle having electric wheels which are excellent in the degree of freedom of mounting (loading), and in the reliability of not causing failure in the motors.

It is preferred that the rotary shaft of each wheel has an axial direction, a radial direction, and a circumferential direction and the plurality of rotary electric machines are arranged at locations which are the same distance from the rotary shaft of each wheel in the radial direction of the rotary shaft of each wheel, which are the same in the axial direction of the rotary shaft of each wheel, and which are mutually separated by predetermined angles in the circumferential direction of the rotary shaft of each wheel. This may facilitate the arrangement of a torque transmission mechanism for transmitting torque from the rotary electric machines to the respective wheels.

Preferably, the locations of the plurality of rotary electric machines are over the rotary shaft of each wheel. This may ensure a space adjacent to the wheel on the lower side of the axle, so that safety and running property may be improved. Moreover, the slightly upper positioning of the center of gravity of the unsprung portion, can mitigate the input from the road surface that would have been caused by the unsprung load.

Preferably, the apparatus according to claim 2, wherein the plurality of rotary electric machines are common in configurations thereof. This may facilitate the change and mounting of the rotary electric machines and reduce the number of parts.

The controller may include means for determining whether or not any of the plurality of rotary electric machines has a malfunction in the operations thereof and means for, if any machine has the malfunction, making the remaining rotary electric machines other than malfunctioning machine produce a predetermined torque to be given to each wheel. Thus, if one of the rotary electric machines turns out to be in failure, wheel driving may be maintained by other rotary electric machines, by which the reliability of running can be improved.

By way of example, the apparatus further comprises a first wheel pair consisting of the single pair of right and left wheels driven individually as the electric wheels, a second wheel pair consisting of a further single pair of right and left wheels other than the wheels of the first wheel pair, a generator powering the rotary electric machines, and an internal combustion engine driving the generator and supplying power to the second wheel pair. This may reduce the number of rotary electric machines required for driving the wheels, and simplify the structure.

The controller may include means for controlling, in addition to the operations of the rotary eclectic machines, operations of the generator on the basis of an operation mode including a regenerative braking mode in which both the generator and the rotary electric machines generate power during a period of time in which the vehicle is in regenerative braking. This may enable regenerative braking of all of the four wheels, thereby providing excellent braking performance.

By way of example, the operation mode further includes a two-wheel driving mode in which the wheels of the second wheel pair is driven by the power from the internal combustion engine, a four-wheel driving mode in which the wheels of the second wheel pair are driven by the power from the internal combustion engine and the wheels of the first wheel pair are driven by the power from the rotary electric machines, and wherein the controlling means has means for performing switches among the two-wheel driving mode, the four-wheel driving mode, and the regenerative braking mode depending on information indicating changes in a speed of the vehicle. Note that it is not necessary to provide a plurality of rotary electric machines to each of all the wheels. Thus, one can drive with the four-wheel driving mode only in low-speed running, for example, at the time of starting, hill-climbing and running on a low-friction road surface, and one can drive with the two-wheel driving mode in any other speed running. In this way, depending on the circumstances, e.g., when the vehicle is in a deceleration period, the rotary electric machines can operate as generators to regenerate electric power in an electric storage device, thus contributing to fuel saving while ensuring running property.

The switching means is, for example, configured to perform the switches between the two-wheel driving mode and the four-wheel driving mode when the vehicle begins to start. Thus, a large acceleration from standstill can be attained. Further, depending on the circumstances, e.g., when the vehicle is in a deceleration period, the rotary electric machines can operate as generators to regenerate electric power in an electric storage device, thus contributing to fuel saving while ensuring running property.

By way of example, at least one of the plurality of rotary eclectic machines has a rated capacity greater than a rated capacity of the generator. Thus, the regenerative electric power on the axle side may be made larger than that of the generator. Accordingly, the size of the generator can be reduced, and thus spatial reduction of the engine room can also be realized.

It is preferred that the rotary electric machines are greater in the number of pairs of magnetic poles than the generator. This may allow the induced voltage of the rotary electric machines, whose number of revolutions is lower than that of the generator, to be raised up to substantially the same level as the system voltage (i.e. battery voltage).

It is also preferred that the rotary electric machines are greater in a rated voltage than the generator. This may reduce the size of the rotary electric machines, and thus reduce the unsprung load of the vehicle without losing the power performance.

By way of example, the apparatus further comprises a torque transfer unit reducing outputs of the plurality of rotary electric machines to transfer the reduced outputs to the shafts, wherein the torque transfer unit comprises either a first pulley or a first sprocket attached to the rotary shaft of each of the wheels, either a second pulley or a second sprocket attached to the rotary shaft of each of the plurality of rotary electric machines, and a belt linking either the first pulley or the first sprocket and all of either the second pulley or the second sprocket, every wheel, to transfer the torque therebetween This may allow omission of gears or chains, for preventing noise that would have otherwise been caused by them, and accordingly may allow omission of lubricating devices. As a result, the structure may be simplified.

Preferably, each wheel is equipped with a braking unit with a rotational member positioned on each wheel side and either the first pulley or the first sprocket is fixedly attached to the rotational member. Thus, the number of component parts may be reduced. In particular, by allowing a brake drum to also operate as a hub portion of the pulley, a pulley hub may be omitted.

By way of example, the plurality of rotary electric machines are two in number, either the second pulley or the second sprocket are fixedly attached to the rotary shafts of the two rotary electric machines, respectively, and the controller is configured to control the operations of the two rotary electric machines such that the belt between the two pulleys or the two sprockets is imparted with a tensile force. Thus, the belt between the pair of pulleys or sprockets on the side of each of the rotary electric machines may be imparted with a tensile force, which may enable smooth power transmission without loosening the belt.

Preferably, the torque transfer unit comprises an idle pulley which is located between the two pulleys or the two sprockets so as to change a transfer direction of the belt. Thus, the contact-angular ranges (contact angles) of the pulleys or sprockets on the side of each of the rotary electric machines with respect to the belt may be formed in an economized space.

As an example, the plurality of rotary electric machines are three or more in number, the belt is a double-side belt, and the three or more rotary electric machines include two rotary electric machines located adjacently with each other, the mutually-adjacent two rotary electric machines rotating oppositely in rotational directions to each other via the double-side belt. Thus, even if the number of rotary electric machine is increased, the contacted ranges with respect to the belt may be effectively formed to enable power transmission in an economized space.

It is preferred that the torque transfer unit is accommodated in side each wheel. Thus, since the belt power transmission systems each including the pulleys or sprockets are accommodated inside the respective wheels, the luggage compartment and the passenger compartment may be enlarged. Further, waterproof sealing may be readily effected to the respective wheels.

As another aspect of the present invention, there is provided an apparatus equipped with electric wheels, comprising: a generator generating electric power in response to drive from an internal combustion engine; a plurality of rotary electric machines supplying power to wheels, respectively, which serve as the electric wheels; a battery that is in charge of transfer of eclectic power between the generator and each of the plurality of rotary electric machines; and a controller controlling operations of both the generator and the plurality of rotary electric machines, the control using a regenerative braking mode allowing both the generator and the plurality of rotary electric machines to generate electric power during a period of time during which the vehicle is in a regenerative braking state.

Specifically, in a so-called hybrid electric vehicle using electric wheels, the present invention can realize a large braking force owing to the regenerative braking performed by both the generator for transmitting and receiving torque between itself and the internal combustion engine at the time of regenerative braking, and the respective rotary electric machines. Particularly, in a system in which the front wheels are driven by the internal combustion engine, and the rear wheels are driven by the rotary electric machines, this arrangement can realize a four-wheel regenerative braking, i.e. an excellent braking performance by distributing the braking force.

Still another aspect of the present invention, there is provided an apparatus equipped with electric wheels, comprising: rotary electric machines individually powering wheel assemblies serving as the electric wheels, the wheel assemblies each having a rotary shaft and a wheel; a controller controlling the operations of the rotary electric machines; either a first pulley or a first sprocket fixedly attached to either the rotary shaft or the wheel of each wheel assembly; either a second pulley or a second sprocket fixedly disposed to position outward in a radial direction of either the first pulley or the first sprocket in the wheel of each wheel assembly; a belt linking either the first pulley or the first sprocket and either the second pulley or the second sprocket to transfer a torque therebetween, wherein each of the rotary electric machines are shifted from an axle of each wheel and either the second pulley or the second sprocket is fixedly secured on the rotary shaft of each wheel.

In this way, the simplified structure allows reduction of the number of revolutions of the rotary electric machines for transmission to the wheels. Further, the simplified structure allows individual driving of the respective electric wheels by the rotary electric machines, without using the engagement of gears. Furthermore, comparing with the arrangement in which the rotary electric machines and the respective electric wheels engage with each other, the arrangement of the present invention can effectively reduce noise, improve environmental resistance, and reduce the weight of the electric wheels.

### BRIEF DESCRIPTION OF THE DRAWINGS

In the accompanying drawings:

FIG. 1 is a schematic cross section along the axial direction of an electric wheel of a vehicle according to a first embodiment of the present invention;

FIG. 2 is a side elevation of the electric wheel shown in FIG. 1 as viewed along a II-II line from the inside of the electric wheel toward the axial direction;

FIG. 3 is a schematic top view of an electric system of a vehicle of a vehicle loading the electric wheels shown in FIG. 1;

FIG. 4 is a side elevation showing a modification of the electric wheel according to the first embodiment;

FIG. 5 is a side elevation showing an electric wheel of a vehicle according to a second embodiment of the present invention;

FIG. 6 is a cross section along the axial direction of an electric wheel of a vehicle according to a third embodiment of the present invention;

FIG. 7 is an enlarged view of the principal part of FIG. 6;

FIG. 8 is a schematic top view showing an electric system of a vehicle of a vehicle according to a fourth embodiment of the present invention; and

FIG. 9 is a timing diagram showing the control of a vehicle according to a fifth embodiment of the present invention.

### DETAILED DESCRIPTION OF THE PREFERRED EMBODIMENTS

Some embodiments of apparatuses, such as vehicles, each having the electric wheels of the present invention will now be described, with reference to the accompanying drawings.

### First Embodiment

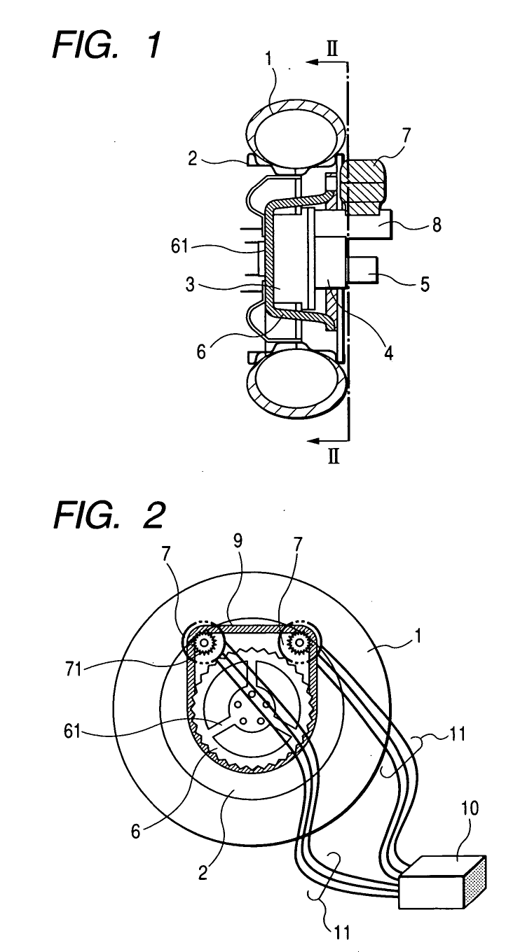

First, with reference to FIGS. 1 to 3, a vehicle having electric wheels according to a first embodiment will now be described.

As shown in FIG. 1, an electric wheel 101 of a vehicle according to the first embodiment comprises a tire 1, a wheel 2, and a brake drum 3, which are mounted in a manner rotatable with an axle (not shown) of the running body (note that AX1 in the figure indicates the axial direction of the axle).

An axle bearing (not shown) rotatably supporting the axel is loaded in the brake drum 3. The fixed side of the axle bearing is supported by a trailing arm 5 through a support member 4. A driven sprocket 6 is fixed to the wheel 2 and the brake drum 3 for clamping them all together. In particular, the driven sprocket 6 is fixed to the axle in the wheel 2 through a hub 61.

Generators/motors (hereinafter also each referred to as MG) 7, each consisting the rotary electric machine referred to herein, are provided in the electric wheel 101 having the configuration described above. The MGs 7 are supported and fixed by a support member 8 at a position offset from the axis of rotation of the electric wheel 101 (note that AX2 in the figure indicates the axial direction of the axis of rotation of the MG 7).

As shown in FIG. 2, in the present embodiment, two MGs 7 are mounted per one electric wheel 101, but the number may be more. In the present embodiment, the two MGs 7 are arranged at the positions distanced in the radial direction of the axle by the same length, and on the same plane normal to the axial direction of the axle, being apart from each other in the circumferential direction of the axle with a predetermined angle therebetween.

A driving sprocket 71 is fixed to the rotary shafts of the MGs 7. As shown in FIG. 2, the power generated by the MGs 7 is transmitted from the driving sprocket 71 to the driven sprocket 6 through a cog belt 9. In the present embodiment, the power transmission portion including the driven sprocket 6 and the cog belt 9 are laid out so as to be accommodated inside the wheel 2.

As shown in FIG. 2, the two MGs 7 are electrically connected to an inverter device 10 through two pairs of three-phase cables 11. The inverter device 10 includes a pair of three-phase inverters with which the two MGs 7 are individually subjected to the drive control. Note that if a rotational angle between a stator and a rotor of one of the two MGs 7 constantly agrees with that of the other of the two MGs 7 by the adjustment, for example, of a timing belt, this may enable a single three-phase inverter to parallelly supply power to these two MGs 7.

In the present embodiment, the two MGs 7 are constituted of magnetic rotor type three-phase synchronous machines, respectively, of the same model, which are driven in the same rotational direction with the same number of revolutions. Thus, rotational power is transmitted from the driving sprocket 71 to the driven sprocket 6 through the cog belt 9 to rotatably drive the latter in the same direction as the former. Accordingly, the wheel 2, to which the driving sprocket 6 is fixed, is rotatably driven about the axle together with the tire 1.

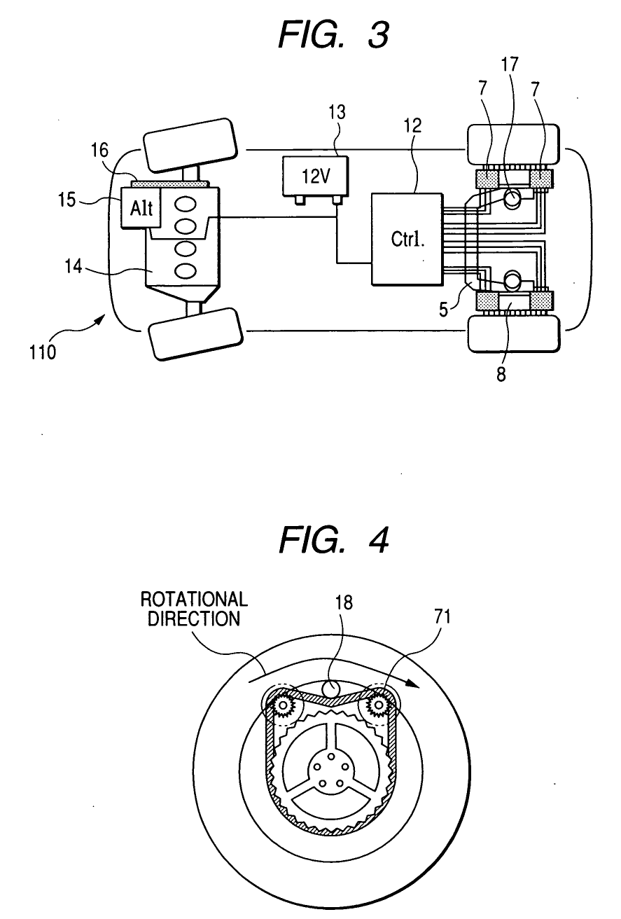

A vehicle loading the electric wheels 101 of the above configuration is described hereunder with reference to FIG. 3.

The vehicle shown in FIG. 3 is the one that applies an automobile. A vehicle body 110 is provided therein with a controller 12, a battery (on-vehicle battery) 13 of predetermined voltage (e.g. 12V), and an alternator 15 serving as a generator, in addition to a pair of rear wheels consisting of the electric wheels 101 which are driven by the MGs 7 as described above, and a pair of front wheels 102 which are driven by an internal combustion engine (engine) 14.

The controller 12 incorporates therein with a pair of inverter devices 10 described above (see FIG. 2), and a control unit (not shown) for controlling a total of four three-phase inverters included in the pair of inverter devices 10. The alternator 15 is a generator/motor which is driven by the rotation of a crankshaft in the engine 14 through a belt 16, and stores the generated electric power in the on-vehicle battery 13. The battery 13 supplies power to each of the MGs 7 through the inverter devices 10. Note that components around the tires 1 of the electric wheels 101 are suspended from the vehicle body by an attenuator/damper which also serves as a coil spring.

In this arrangement, the controller 12 controls the respective MGs 7 with a preset electromotive (power running) mode or a power generating (regenerative braking) mode, according to vehicle driving conditions. In the electromotive mode, power is supplied to each of the MGs 7 from the alternator 15 that serves as a generator and from the battery 13 through the inverter devices 10. In the power generating mode, the electric power (regenerative electric power) generated by the respective MGs 7 is stored in the on-vehicle battery 13. If required, the electric power is consumed to electrically drive the alternator 15. Note that the controller 12 also controls the power generation or the electromotive operation of the alternator 15, in addition to the control of the respective MGs 7.

Hereinafter is described the general operation of the present embodiment.

The supply of fuel to the engine 14 is controlled according to the stepping angle of an accelerator pedal (not shown) by a motor vehicle driver. Thus, the pair of front wheels 102 is driven by way of a known torque transmission system for vehicle, not shown. The pair of rear wheels consisting of the electric wheels 101 is driven by the respective pairs of MGs 7. It is apparent that the pair of MGs 7 for driving the same one wheel constitutes the rotary electric machines referred to herein.

In performing the driving described above when a motor vehicle is started, rear-wheel driving is performed by the MGs 7, in addition to the front-wheel driving by the engine. When a motor vehicle travels straight ahead, the controller 12, as a matter of course, carries out control to match the torque and the number of revolutions between the two rear wheels. This may achieve a stable starting performance in comparison with the case where two front wheels are simply driven by an engine. In particular, in low-friction road surface conditions or the like in winter time, skidding of the rear wheels can be suppressed.

In the present embodiment, the cog belt 9 is used for torque transmission between the MGs 7 and the wheel 2. Comparing with the driving caused by engagement between gears, torque transmission in this manner provides such excellent advantages as reduction of noise and omission of a lubricating mechanism.

Further, in the present embodiment, the center of gravity of the two MGs 7 is located above the center of axle. Thus, environmental resistance, i.e. effects of preventing entry such as of dust and moisture can be improved, and the input from the road surface to the vehicle body caused by the increase of unsprung load can be mitigated.

(Modification)

A modification of the first embodiment provided above is described hereunder with reference to FIG. 4. In this modification, an idle pulley 18 is mounted at the driving sprocket 71 between the two MGs 7 in the electric wheel 101 described above. The idle pulley 18 is rotatably attached to the side of the vehicle body in the same manner as the housing of each MG 7 to press the cog belt 9 inward in the radial direction of the axle of the electric wheel 101. Thus, the wound angular ranges (i.e., contact angles) of the cog belt 9 with respect to the two MGs 7 may be formed in an economized space to thereby improve the torque transmission performance.

In the present modification, the torque generated by the MG 7 (the right one in FIG. 4), which is forwardly positioned in the rotational direction shown in FIG. 4, is controlled to be larger than that of another MG 7 (the left one in FIG. 4). This causes tension in the cog belt 9 between the two MGs 7 for preventing the looseness thereabout, so that smoother power transmission can be achieved.

### Second Embodiment

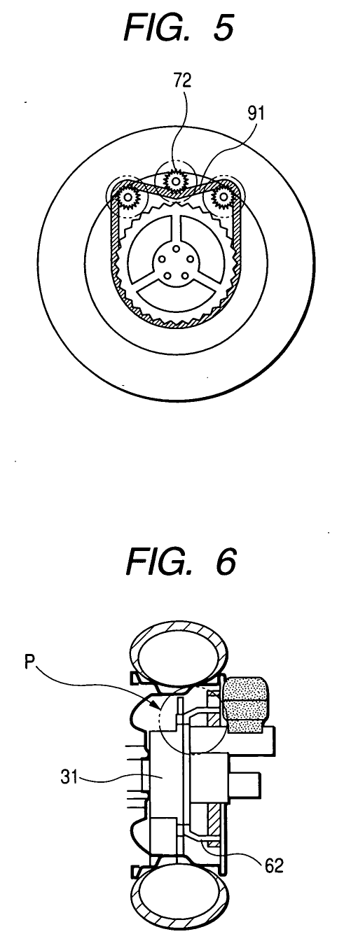

An electric wheel of a vehicle according to a second embodiment is described hereunder with reference to FIG. 5.

As shown in FIG. 5, in the present embodiment, a third MG 72 is mounted between the two MGs 7 in the electric wheel 101 shown in FIGS. 2 and 4, and a double-side soothed cog belt 91 is used as a cog belt. The remaining arrangement is the same as the first embodiment.

The MG 72 has the same number of revolutions as the two MGs 7 but rotates in the reverse direction. Thus, in the present embodiment, driving power can be readily enhanced without losing the transmission performance of the belt.

Note that, in the present embodiment, the more the transmission power is increased, the wider the belt width may be set. By arranging more odd-number MGs 7 and even-number MGs 72 in the same manner, the double-side soothed cog belt 91 can be driven with more number of MSs 7 and MGs 72, so that, also, the wound angular range of the belt with respect to each MG 7 may be formed in an economized space.

### Third Embodiment

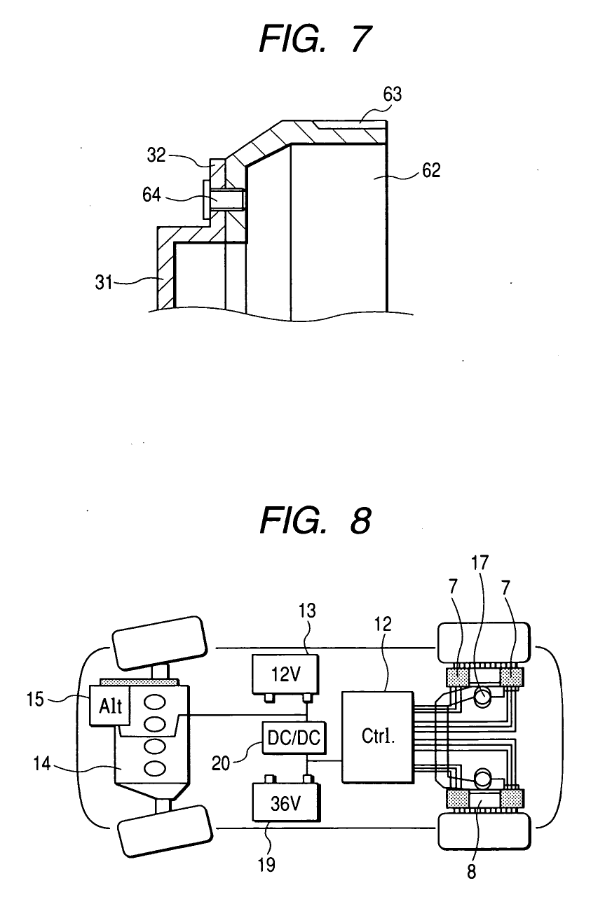

An electric wheel of a vehicle according to a third embodiment is described hereunder with reference to FIGS. 6 and 7.

As shown in FIG. 6, in the present embodiment, a driven sprocket 62 is fixedly fastened to the brake drum 31 in the electric wheel 101 shown in FIG. 1. An enlarged view of a portion P, i.e. the fixedly fastened portion, is shown in FIG. 7 to show the detail. As can been seen from the figure, the driven sprocket 62 is fastened at a flange 32 of the brake drum 31 through a plurality of bolts 64. Indicated by numeral 63 in the figure is a soothed portion of the driven sprocket 62 which is to be in contact with the cog belt 9. The remaining arrangement is the same as the first embodiment.

According to the present embodiment, a portion of the fixed hub 61 of the driven sprocket 62 can also serve as a hub of the brake drum 31. As a result, such effects can be expected as much more reduction of the number of parts, and the reduction of the unsprung load caused by the reduction in the weight of parts.

### Fourth Embodiment

A vehicle according to a fourth embodiment is described with reference to FIG. 8.

As shown in FIG. 8, in the vehicle described above and shown in FIG. 3, the present embodiment sets the rated voltage of each MG 7 at a higher value than that of the alternator 15. Further, in addition to the battery (low-voltage battery) 13 having a rated voltage of 12V, another battery (high-voltage battery) 19 having a rated voltage, for example, of 36V (42V when fully charged) is loaded. The high-voltage battery 19 and the low-voltage battery 13 are connected through a two-way DC/DC converter 20, enabling two-way reception/transmission of electric power between the two batteries.

If the output capacities of the rotary electric machines constituting the respective MGs 7 are equal to each other, the power consumption of the machines can be reduced by raising the operating voltage to make the machines smaller. Thus, according to the present embodiment, reduction in the size and weight of each MG 7 can be much more enhanced, which may enable more reduction of the unsprung weight. In addition, by reducing the current, size and loss reduction of the power control machinery, such as an inverter, may also be achieved.

Moreover, in the present embodiment, use of the two-way DC/DC converter 20 may enable electrical insulation of the high-voltage system from the grounded low-voltage system, and thus may improve electrical safety of the high-voltage system.

The two voltage systems can thus be individually controlled. As a result, under the control of the two-way DC/DC converter 20 and the controller 12, such a control may be carried out as to allow large voltage variation to the high-voltage system, and to set voltage regulation of the low-voltage system at a small level. The low-voltage system is the vehicle power system for general current consumers (i.e. electric loads), and is required to supply power to various computers, lights, control motors and the like. For this reason, the voltage variation must be suppressed to fall within a predetermined range. In case a common battery is used as in the first embodiment, the voltage variation of the respective MGs 7 resulting from the variation of the driving conditions causes the source voltage variation for these loads, requiring addition of means for avoiding such a variation. In the present embodiment, however, such a problem may be readily resolved.

### Fifth Embodiment

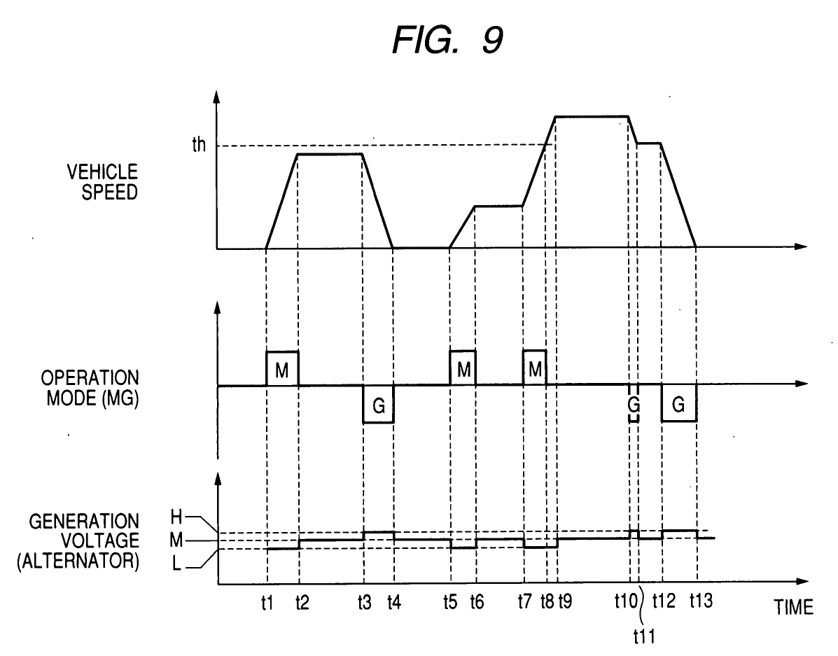

A vehicle of a fifth embodiment is described with reference to FIG. 9. In the present embodiment, there is described an example of vehicle control, in which the vehicle according to the fourth embodiment is used.

FIG. 9 is a timing diagram showing an example of control of the MGs 7 and the alternator 15. Note that, since the output current control of the alternator 15 and the control for allowing the alternator 15 to operate as a generator, per se, are well known, detailed description of the controls is omitted herein. The inverter control, per se, of each MG 7 as a three-phase synchronous machine is also well known, and thus detailed description on the control is omitted herein.

In the timing diagram shown in FIG. 9, the upper section indicates the variation of vehicle speed, the middle section indicates the operation mode of the MGs 7, and the lower section indicates the generation voltage of the alternator 15.

A symbol M in the operation mode of the MGs 7 in the timing diagram refers to a motor mode (electromotive mode) in which the MGs 7 are driven as motors. A symbol G refers to a generator mode (generating mode) in which the MGs 7 are driven as generators. The blank portions correspond to a stop mode in which the MGs 7 are driven neither as generators nor as motors. The switching between these operation modes is controlled by the controller 12 according to the variation of vehicle speed (e.g., at the time of starting, accelerating, steady-speed running and decelerating). Note that the regenerative braking mode of the present invention corresponds to the generating mode, the two-wheel driving mode corresponds to the stop mode, and the four-wheel driving mode corresponds to the electromotive mode.

In the timing diagram, symbols L, M and H in the generating voltage of the alternator 15 may represent, for example, 12.8V, 14.0V and 15.0V, respectively. The switching between L, M and H is also controlled by the controller 12 according to the variation of vehicle speed (e.g., at the time of starting, accelerating, steady-speed running and decelerating).

As shown in FIG. 9, during the acceleration period (t7-t8) and starting periods (t1-t2 and t5-t6), the MGs 7 operate in the motor mode to assist driving force for acceleration, including that at the time of starting. During the steady-speed running periods (t2-t3, t6-t7, t9-t10 and t11-t12), the MGs 7 operate in the stop mode. During the deceleration periods (t3-t4, t10-t11 and t12-t13), the MGs 7 operate in the generator mode to store the regenerative electric power generated by the respective MGs 7 in the low-voltage battery 13 and the high-voltage battery 19 through the controller 12 and the two-way DC/DC converter 20 (see FIG. 8). Note that, even in the acceleration period and the starting periods, the vehicle speed may sometimes exceed a predetermined value “th.” During such a speed exceeding period (t8-t9), the operation of the MGs 7 transfers from the motor mode to the stop mode to suppress consumption of electric power. This is because, when vehicle speed is sufficiently high, the efficiency of engine is enhanced, and the efficiency of the MGs 7, i.e. the rotary electric machines, is relatively decreased, meaning that it is desirable to stop the MGs 7.

On the other hand, the alternator 15 which is driven by the crankshaft of the engine 14, changes the generation voltage in each of the acceleration period, the starting periods, the steady-speed running periods and the deceleration periods. For example, in each of the acceleration period and the starting periods (t1-t2, t5-t6 and t7-t8), the generation voltage is decreased to L (12.8V), so that the engine load is decreased. During the deceleration periods (t3-t4, t10-t11 and t12-t13), the generation voltage is increased to H (15.0V), so that the deceleration energy is regenerated through the transmission for storage in the battery 13. During the steady-speed running periods (t2-t3, t6-t7, t9-t10 and t11-t12), the generation voltage is rendered to be M (14.0V), i.e. the normal condition, so that electric power is supplied to the on-vehicle machinery.

Thus, control of the operation mode of the MGs 7 and the generation voltage of the alternator 15 may enable power assist at the time of starting, may enable better responsiveness than the conventional mechanical 4-WD vehicles, and may enable fine torque control, while performing effective recovery of deceleration energy. In particular, although regenerative braking performed only by the alternator 15 may tend to cause loss in the transmission, the present embodiment can enhance the regenerative braking efficiency owing to the direct energy recovery from the axle.

According to each of the embodiments described above, more excellent effect of increasing wheel driving power can be exerted comparing with the conventional electric wheels, while decreasing the inertial mass of the rotary electric machines. In addition, degree of freedom of loading can also be increased by the dispersed distribution of the small rotary electric machines, avoiding interference with other suspension parts or the like.

Additionally, fuel consumption of hybrid electric vehicles can be effectively improved, while achieving small capacity electric power system, owing to the provision of the pair of wheels driven by the internal combustion engine, and the pair of electric wheels driven by the rotary electric machines. In this way, the balance between costs and performance can also be improved, realizing enlargement of the vehicle interior space, which is peculiar to vehicles of electric wheels.

Further, by using the small rotary electric machines, the following effects can also be attained from the generally known relation between the output of rotary electric machines and the moment of inertia of their rotating portions.

Specifically, the output of rotary electric machines is generally in proportion to their magnetic loading. For example, when a diameter of a rotor of a rotary electric machine is indicated by D and an effective axial length is indicated by L, the magnetic loading is expressed by D²×L. Accordingly, assuming that the same magnetic loading is realized by two small-diameter rotary electric machines, the diameter of these machines will be about 1/1.4 relative to a single rotary electric machine in use. Further, the moment of inertia of a rotor is expressed by G×D², where G is in proportion to (π/4)×D²×L. Accordingly, the moment of inertia of a large rotary electric machine is in proportion to (π/4)×D⁴×L. Contrarily, the moment of inertia of the two small rotary electric machines is expressed by (π/8)×D⁴×L, which means achievement of significant reduction. Additionally, since the mass-production conventional motors can be utilized as such small-size rotary electric machines, an effect of significantly reducing manufacturing costs including changing costs can be expected.

In each of the embodiments described above, the two MGs 7 are arranged at the positions distanced in the radial direction of the axle by the same length, and on the same plane normal to the axial direction of the axle, being apart from each other in the circumferential direction of the axle with a predetermined angle therebetween. As a result, a particularly good effect, i.e. to readily enable torque distribution control between the two MGs 7, can be achieved.

Further, since motors of the same model are employed as the two MGs 7, volume efficiency can be enhanced and thus maintenance is simplified.

According to the present invention, malfunction of the MGs 7 may be readily detected by measuring the current to the MGs 7. Therefore, in the event malfunction of one MG 7 and the three-phase inverter driving the MG 7 is detected, the wheel output of the other MG 7 may be permitted to increase within the rated capacity range. Thus, reliability of operation can be significantly enhanced.

In the embodiments described above, the arrangement has been such that the front wheels are driven by the engine, and the rear wheels are driven by the motors. However, the reverse arrangement is also possible, i.e. the front wheels may be driven by the motors, and the rear wheels may be driven by the engine.

Note that the present invention should not be limited to the embodiments described above. Needless to say, the technical concept of the present invention may be combined with other known techniques, or other techniques of which the required function is common to that of the present invention.

What is claimed is:

1. An apparatus equipped with electric wheels for movement, comprising:
a single pair of right and left wheels each having a rotary shaft;
a plurality of rotary electric machines driving the single pair of right and left wheels so that the wheels serve as the electric wheels, wherein the plurality of rotary electric machines each have a rotary shaft positionally shifted from the rotary shaft of each wheel and drive the same wheel of the single pair of right and left wheels; and
a controller controlling operations of the rotary electric machines.

2. The apparatus according to claim 1, wherein the rotary shaft of each wheel has an axial direction, a radial direction, and a circumferential direction and
the plurality of rotary electric machines are arranged at locations which are the same distance from the rotary shaft of each wheel in the radial direction of the rotary shaft of each wheel, which are the same in the axial direction of the rotary shaft of each wheel, and which are mutually separated by predetermined angles in the circumferential direction of the rotary shaft of each wheel.

3. The apparatus according to claim 2, wherein the locations of the plurality of rotary electric machines are over the rotary shaft of each wheel.

4. The apparatus according to claim 2, wherein the plurality of rotary electric machines are common in configurations thereof.

5. The apparatus according to claim 1, wherein the controller includes means for determining whether or not any of the plurality of rotary electric machines has a malfunction in the operations thereof and means for, if any machine has the malfunction, making the remaining rotary electric machines other than malfunctioning machine produce a predetermined torque to be given to each wheel.

6. The apparatus according to claim 1, further comprising
a first wheel pair consisting of the single pair of right and left wheels driven individually as the electric wheels,
a second wheel pair consisting of a further single pair of right and left wheels other than the wheels of the first wheel pair,
a generator powering the rotary electric machines, and
an internal combustion engine driving the generator and supplying power to the second wheel pair.

7. The apparatus according to claim 6, wherein the controller includes means for controlling, in addition to the operations of the rotary eclectic machines, operations of the generator on the basis of an operation mode including a regenerative braking mode in which both the generator and the rotary electric machines generate power during a period of time in which the vehicle is in regenerative braking.

8. The apparatus according to claim 7, wherein the operation mode further includes
a two-wheel driving mode in which the wheels of the second wheel pair is driven by the power from the internal combustion engine,
a four-wheel driving mode in which the wheels of the second wheel pair are driven by the power from the internal combustion engine and the wheels of the first wheel pair are driven by the power from the rotary electric machines, and
wherein the controlling means has means for performing switches among the two-wheel driving mode, the four-wheel driving mode, and the regenerative braking mode depending on information indicating changes in a speed of the vehicle.

9. The apparatus according to claim 8, wherein the switching means is configured to perform the switches between the two-wheel driving mode and the four-wheel driving mode when the vehicle begins to start.

10. The apparatus according to claim 6, wherein at least one of the plurality of rotary eclectic machines has a rated capacity greater than a rated capacity of the generator.

11. The apparatus according to claim 6, wherein the rotary electric machines are greater in the number of pairs of magnetic poles than the generator.

12. The apparatus according to claim 6, wherein the rotary electric machines are greater in a rated voltage than the generator.

13. The apparatus according to claim 1, further comprising a torque transfer unit reducing outputs of the plurality of rotary electric machines to transfer the reduced outputs to the shafts,
wherein the torque transfer unit comprises
either a first pulley or a first sprocket attached to the rotary shaft of each of the wheels, either a second pulley or a second sprocket attached to the rotary shaft of each of the plurality of rotary electric machines, and a belt linking either the first pulley or the first sprocket and all of either the second pulley or the second sprocket, every wheel, to transfer the torque therebetween.

14. The apparatus according to claim 13, wherein each wheel is equipped with a braking unit with a rotational member positioned on each wheel side and either the first pulley or the first sprocket is fixedly attached to the rotational member.

15. The apparatus according to claim 13, wherein the plurality of rotary electric machines are two in number,
either the second pulley or the second sprocket are fixedly attached to the rotary shafts of the two rotary electric machines, respectively, and
the controller is configured to control the operations of the two rotary electric machines such that the belt between the two pulleys or the two sprockets is imparted with a tensile force.

16. The apparatus according to claim 15, wherein the torque transfer unit comprises an idle pulley which is located between the two pulleys or the two sprockets so as to change a transfer direction of the belt.

17. The apparatus according to claim 13, wherein the plurality of rotary electric machines are three or more in number,
the belt is a double-side belt, and
the three or more rotary electric machines include two rotary electric machines located adjacently with each other, the mutually-adjacent two rotary electric machines rotating oppositely in rotational directions to each other via the double-side belt.

18. The apparatus according to claim 13, wherein the torque transfer unit is accommodated in side each wheel.

19. An apparatus equipped with electric wheels, comprising:
a generator generating electric power in response to drive from an internal combustion engine;
a plurality of rotary electric machines supplying power to wheels, respectively, which serve as the electric wheels;
a battery that is in charge of transfer of eclectic power between the generator and each of the plurality of rotary electric machines; and
a controller controlling operations of both the generator and the plurality of rotary electric machines, the control using a regenerative braking mode allowing both the generator and the plurality of rotary electric machines to generate electric power during a period of time during which the vehicle is in a regenerative braking state.

20. An apparatus equipped with electric wheels, comprising:
rotary electric machines individually powering wheel assemblies serving as the eclectic wheels, the wheel assemblies each having a rotary shaft and a wheel;
a controller controlling the operations of the rotary electric machines;
either a first pulley or a first sprocket fixedly attached to either the rotary shaft or the wheel of each wheel assembly;
either a second pulley or a second sprocket fixedly disposed to position outward in a radial direction of either the first pulley or the first sprocket in the wheel of each wheel assembly;
a belt linking either the first pulley or the first sprocket and either the second pulley or the second sprocket to transfer a torque therebetween,
wherein each of the rotary electric machines are shifted from an axle of each wheel and either the second pulley or the second sprocket is fixedly secured on the rotary shaft of each wheel.
